(19) United States
(12) Patent Application Publication
(10) Pub. No.: US 2024/0233509 A1
(43) Pub. Date: Jul. 11, 2024

(54) HAZARD MANAGEMENT SYSTEM AND HAZARD SENSOR UNIT

(71) Applicant: Hilti Aktiengesellschaft, Schaan (LI)

(72) Inventors: Inka BAUMGART, Landsberg am Lech (DE); Michele CRABOLU, Buchs (CH); Giovanni BELLUSCI, Buchs (CH); Xaver HANSLMEIER, Mauerstemen (DE); Eduard SEVER, Ludesch (AT)

(21) Appl. No.: 18/289,106

(22) PCT Filed: May 6, 2022
(86) PCT No.: PCT/EP2022/062249

§ 371 Date: Oct. 31, 2023

(30) Foreign Application Priority Data
May 21, 2021 (EP) 21175353.8

(51) Int. Cl. G08B 21/12; G08B 21/18

(52) U.S. Cl. CPC G08B 21/12; G08B 21/182

(57) ABSTRACT

A hazard management system for a construction site is provided, including a hazard sensor unit, a control unit, and a piece of construction equipment, wherein the hazard sensor unit is configured to determine at least one hazard measured value of the construction site for at least one hazard, wherein the control unit is configured to evaluate the hazard measured value, and wherein the control unit is configured to control the construction equipment to switch the construction equipment on and/or off and/or to set a working parameter, and/or to provide a user of the hazard management system with a control signal for controlling the construction equipment. A hazard sensor unit is also provided.

The invention relates to a hazard management system for a construction site and to a hazard sensor unit.

Construction equipment for carrying out construction work is used by construction workers on construction sites. The construction workers using the construction equipment—in general, persons located at the given construction site—are accordingly exposed to different hazards. Some construction equipment generates dust, for example, due to its specific demolition function. Exposure to dust can cause health impairments, for example, depending the chemical composition, quantity and particle size distribution thereof, as well as the exposure duration for the construction workers. For this reason, limit values for these hazards, for example dust limit values, must usually be observed on construction sites to protect the construction workers.

Usually, the dust emission of construction equipment is measured under laboratory conditions—in particular, in isolation—and subsequently evaluated with respect to applicable limit values. However, in practice, the construction workers are not only exposed to dust which is caused by the construction equipment in question, but also dust which, for example, is caused by other construction equipment which is also used at the construction site. In addition, different localized boundary conditions can influence local dust concentrations. Such boundary conditions are the result of, for example, the local ventilation situation, wind speeds, moisture, turbulence caused by construction site vehicles, or the like.

Solutions are therefore desirable which allow for determining a dust exposure of the construction workers located on a construction site, and as a result allow the implementation of suitable protective measures for protecting the construction workers. In this case, dusts represent only one example of possible hazards to which the construction workers may be exposed.

DE 10 2016 219 312 A1 describes, inter alia, a method for soil remediation. In one variant of the method, pollutant concentrations in the air in a suction intake are continuously measured.

WO 2021 021812 A1 discloses a crane hazard logic and a system and a method for using the same.

U.S. Pat. No. 2,018,232 679 Al discloses a device for terminating and reporting impermissible uses of machines.

DE 10 2017 221 852 A1 discloses a system and a method for monitoring a work situation.

The object of the present invention is therefore to offer devices with which construction site hazards can be detected, and protective measures can be taken for persons located at the construction site.

The object is achieved by a hazard management system for a construction site, in particular an elevated construction site, an underground construction site, and/or a component prefabrication site, comprising a hazard sensor unit, a control unit, and a piece of construction equipment, wherein the hazard sensor unit is configured to determine at least one measured hazard value of the construction site for at least one hazard, wherein the control unit is configured to evaluate the measured hazard value, and wherein the control unit is configured to control the construction equipment, for example to switch on, to switch off, and/or to set a working parameter, in particular the operating power, for the construction equipment, and/or to output a control signal to a user of the hazard management system to control the construction equipment.

The invention is therefore based on the idea of detecting at least one hazard at the construction site by means of the hazard sensor unit using the measured hazard value. The control unit can then evaluate the measured hazard value. For example, it can derive a hazard evaluation from the measured hazard value.

The term “construction site” in the context of the invention can include any locations where persons are exposed to hazards by construction activities. In particular, a construction site can also be understood to mean a component prefabrication site where a component, for example a finished component, for example a ceiling, floor or wall element of a building, is prefabricated. Persons engaging in construction activities can also be exposed to typical hazards such as dust at such component prefabrication sites.

Construction equipment can generally be understood to mean devices, tools, and the like which are used on a construction site. In particular, construction equipment can be understood to mean electrically operable devices, for example electrical handheld power tools, construction robots, dedusters, air scrubbers, suction devices or the like.

The control unit can be configured to control the construction equipment, in particular to switch on the construction equipment, to switch off the construction equipment, and/or in particular to set the working parameter thereof according to the hazard evaluation. The working parameter can in particular be an operating power of the construction equipment.

It can be configured to control the construction equipment directly.

Alternatively or additionally, the control unit can be configured to provide the control signal for controlling the construction equipment to the user of the hazard management system. It can thus be configured for indirect control of the construction equipment. For example, the control signal can be output in an output unit of the construction equipment. The control signal can be, for example, a visual signal, for example an illumination of a light source and/or a characteristic visual signal shown on a display unit, and/or an acoustic signal, for example a warning tone. The control signal can be output in the control unit and/or generally on an element of the hazard management system, for example the construction equipment, on a smartphone, a wearable, a headset, a helmet, or the like. The control signal can be designed to recommend a control action of the construction equipment to the user. If, for example, the construction equipment is an air cleaning device, the control signal can be designed in such a way that the user is prompted to control, for example to switch on and/or regulate the operating power of, the air cleaning device when the control signal occurs, in particular upon an acutely poor air quality.

The control unit can thus also be configured to output the measured hazard value and/or the hazard evaluation to an output unit of the hazard management system in order to signal the measured hazard value and/or the hazard evaluation to a user of the hazard management system.

The object is also achieved by a hazard management system for a construction site comprising at least one hazard sensor unit, a control unit, and an output unit, wherein the hazard sensor unit is configured to determine at least one measured hazard value of the construction site for at least one hazard, wherein the control unit is configured to evaluate the measured hazard value, and wherein the control unit is configured to output the measured hazard value and/or a hazard evaluation derived from the measured hazard value to the output unit.

The improvements mentioned below can be contemplated for both solutions.

The output unit can be designed for the optical and/or acoustic output of data and/or signals. In particular, the output unit can be configured to output a warning signal, in particular an acoustic and/or an optical warning signal. The display unit can comprise a display. Alternatively or additionally, the display unit can also be designed as a virtual display unit, for example in the form of a website showing data and/or signals. The display unit can be configured to display multiple measured hazard values and/or multiple hazard evaluations simultaneously. For example, multiple measured hazard values can be detected by hazard sensor units located at different positions of the construction site and can be displayed on the display unit. The display unit can be configured to display a heat map of the obtained data. It is thus possible to represent the obtained measured hazard values in connection with the corresponding position of the measurement. The display unit can be part of the hazard sensor unit, part of a headset, part of a helmet, and/or part of a wearable, part of a smartphone, and/or the like.

A user of the hazard management system can be informed about the measured hazard value and/or the hazard evaluation via the display unit. If necessary, the user can then initiate protective measures for protecting the persons located at the construction site.

It is also conceivable that the control unit is at least partially integrated into the hazard sensor unit. Alternatively or additionally, at least a portion of the control unit can also be designed independently of the hazard sensor unit. The control unit can be designed as a computer unit or have at least one computer unit. The computer unit can be cloud-based. It is also conceivable that only a portion of the computer unit is cloud-based. The control unit can preferably comprise a database system, in particular a cloud-based database system.

The computer unit can have a microcontroller. A program code can be stored in the computer unit to control the computer unit. The program code and/or a hardware component of the computer unit can have and/or form a machine learning unit. The machine learning unit can implement a neural network. It is thus conceivable that the hazard evaluation is determined by means of a pre-trained support vector machine from the measured hazard value. For training the machine learning unit, it is possible to use, as training data for one or more sets, synthetically produced measured hazard value in conjunction with associated hazard evaluations corresponding to the specifications included in standards, for example. Alternatively or additionally, the training data sets can also be formed by measured hazard values measured at real construction sites, wherein a hazard evaluation is added by an expert to a measured hazard value.

If at least a portion of the control unit is cloud-based, its reliability can be increased. It is also conceivable, in particular if the control unit is at least partially cloud-based, that the control unit is part of multiple different hazard management systems, for example hazard management systems which monitor different construction sites.

It is understood that more than one hazard sensor unit and/or more than one piece construction equipment and/or more than one control unit and/or more than one display unit can be integrated into the hazard management system. It is also preferred if the hazard management system has a modular design. It is thus conceivable that the hazard management system has one or more hazard sensor units. It is in particular conceivable that the hazard management system comprises one or more control units and/or one or more pieces of construction equipment.

The hazard management system can have a data network for connecting the elements of the hazard management system to one another. The data network may comprise and/or be a wireless network. The wireless network can be designed according to at least one of the standards commonly known as WLAN, “BLE” or “ZigBee.” In particular, it is conceivable that the data network is an IoT (Internet of Things) network or is at least part of such an IoT network. For data exchange with further devices, the data network can have at least one gateway.

Preferably, at least one element of the hazard management system, in particular the hazard sensor unit, the control unit, the display unit or the construction equipment can have a data interface, for example a WLAN, a BLE- or a ZigBee interface for connection to the data network.

The hazard can be a property occurring at the construction site, which can have an unfavorable effect at least in certain manifestations or under certain conditions for a person located at the construction site or an object located at the construction site. In particular, the hazard can be a temperature, a humidity, a pressure, radiation—in particular infrared, ultraviolet or even shorter-wave electromagnetic radiation, for example X-ray or gamma radiation. It is also conceivable that the hazard relates to air quality. It can correspond, for example, to a concentration of a substance in the ambient air. For example, it can correspond to a concentration of carbon dioxide, to carbon monoxide, or another gas or another solid. It can also relate to one or more types of radioactivity.

In a particularly preferred class of hazard management system, the hazard can be related to dust. For this purpose, the measured hazard value can be a dust-related characteristic value, in particular a silica-related characteristic value.

It is understood that the hazard management system can be configured to take into account one or more hazards, in particular one or more different hazards. For this purpose, the hazard management system, in particular by means of one or more hazard sensor units, can be configured to determine one or more measured hazard values of the construction site from the one or more hazards. Similarly, the control unit can be configured to evaluate one or more measured hazard values. The control unit can be configured to determine one or more hazard evaluations from the one or more measured hazard values.

The hazard management system can be configured to monitor the construction site. In particular, the hazard management system can be configured to monitor the construction site for the presence of one or more hazardous situations. As long as there is no hazardous situation, or at least no hazardous situation is detected, the hazard management system may exert no influence on the construction work occurring at the construction site.

The hazard management system can furthermore be configured to control the construction equipment if the measured hazard value exceeds a first limit value, i.e., in particular if the hazard management system detects the presence of a hazardous situation. The control unit can furthermore be configured to control the construction equipment in the opposite direction of the first control in the even that—in particular, subsequently—the measured hazard value drops below a second limit value. For example, the control unit can be configured to switch on the construction equipment if the first limit value is exceeded, and to switch off the construction equipment if the second limit value is dropped below. By means of the first and the second limit values, the control unit can thus be configured to control the construction equipment with a hysteresis. However, it is also conceivable that the first and the second limit values are the same.

The first and/or the second limit value can be stored in the control unit. For this purpose, the control unit can have one or more storage units for storing the first and/or the second limit value. The first and/or the second limit value can be variable. In particular, they can be variable by a user of the hazard management system. For different hazard sensor units and/or different control units, multiple, in particular different, first and/or second limit values can be provided.

The construction equipment can be or at least comprise a suction device, a blowing device and/or a filter device. This is particularly advantageous if the hazard is in relation to air quality. If the hazard corresponds to, for example, a dust concentration, in particular a silica concentration, of the ambient air or of the air inhaled by the person, the suction device and/or the filter device can clean the corresponding air so that the person can enjoy an improved air quality. Alternatively or additionally, the blower can blow air free of health hazards into the surroundings of the person in order to also improve the air quality.

The construction equipment can also be or comprise work equipment for carrying out construction work. For example, the construction equipment can be a mobile construction machine, for example a construction robot, or a hand-held power tool, in particular for elevated construction work, underground work, and/or for component prefabrication work, or comprise such a construction robot or such a hand-held power tool. The mobile construction machine can be remotely operable. The construction equipment can in particular be configured for use in concrete construction work. It can be a drill, a hammer drill, a writing device, a saw, a chiseling machine or the like, and/or comprise such a machine. If the use of such a piece of construction equipment leads to the hazard of dust being released during work with the construction equipment, the control unit can be configured to throttle the operating power of the construction equipment and/or to completely deactivate the construction equipment. The deactivation can last either temporarily and/or over a longer period of time, for example 15 minutes or 1 hour.

If a hazard management system is used on a construction site, it is essential that the hazard management system can also detect actually existing hazards as quickly as possible. It can be contemplated that the hazard management system, in particular the control unit, is configured to determine a malfunction and/or an operating state of an element of the hazard management system, in particular of the hazard sensor unit and/or of the construction equipment, according to the measured hazard value. This is based on the idea that the measured hazard value can represent information about the hazard, for example a current dust concentration, and/or information about the operability or a malfunction of an element of the hazard management system. It is thus conceivable that the control unit detects a malfunction of the hazard sensor unit if the obtained measured hazard value over a certain minimum period of time assumes a value within a value range that cannot be reached technically, or at least is very unlikely. Alternatively or additionally, such a malfunction can also be detectable by the control unit if the control unit does not receive a measured hazard value from the hazard sensor unit over a certain period of time. The control unit can also be configured to detect a maintenance requirement of at least one element, for example a necessary battery change for a hazard sensor unit, and/or to ensure compliance with at least one maintenance interval.

The control unit can be configured to control, in particular switch off, the construction equipment when a malfunction and/or the detection of a failure of an element is detected.

It is also conceivable for the control unit to be configured for this case, to emit a warning signal to the user of the hazard management system, for example to output it via the output unit.

The hazard sensor unit and/or the control unit can be configured to detect the measured hazard value by way of one or more evaluation modes. For example, a dust-related characteristic value can be embodied as a long-term or short-term measurement value. The long-term measurement value can be a measurement value averaged over 1 to 24 hours, for example 8 h. The short-term measurement value can be a measurement value averaged over 1 to 60 minutes, for example 15 minutes.

The hazard management system, in particular the control unit, can also be configured to plan or control at least one activity of at least one person located at the construction site. For example, the control unit can be configured for a case of detection in which the person has been exposed to an excessively high dust exposure, to allocate the work associated with the affected person to a different person that is not currently overexposed.

The control unit can also be designed to document at least one detected measured hazard value and/or at least one hazard evaluation. For this purpose, it can be configured to store the measured hazard value and/or the hazard evaluation on a data carrier.

The scope of the invention also includes a piece of construction equipment for a hazard management system according to the invention. The construction equipment can be, for example, work equipment, for example a construction robot or a hand-held power tool, in particular for an elevated construction site and/or an underground construction site. The construction equipment can thus be or at least comprise a rotary hammer machine, a chiseling machine or the like. The construction equipment can also be or comprise a filter device, for example an air scrubber, a suction device, a blowing device or generally a controllable protective device, for example an electrically controllable dust helmet.

The construction equipment can particularly preferably be configured to be controllable by the control unit of the hazard management system. In particular, the construction equipment can be configured to be controllable in its operating power and/or to be switched on and/or off by the control unit. For this purpose, the construction equipment can have a data interface, in particular a wireless data interface.

The scope of the invention also includes, furthermore, a hazard sensor unit for use in a construction site, wherein the hazard sensor unit is configured to determine at least one measured hazard value of the construction site for at least one hazard. The hazard sensor unit can be configured for use in the hazard management system according to the invention.

The detected hazard and thus the measured hazard value and the first and/or the second limit value can correspond to a particle concentration, a particle composition, in particular a chemical particle composition, a particle size or the like.

The hazard sensor unit can also be configured to detect particles of certain sizes. For example, it is known for dust that the particle size will influence the manner in which the human body takes up the particles. The particle size can thus also determine the hazard potential of dusts. In particular, the hazard sensor unit can be configured to detect particle sizes of at most 10 μm in diameter, preferably of at most 2.5 μm, with the measured hazard value. Alternatively or additionally, particle sizes of at most 4 μm, in particular at most 1 μm, or also at most 0.5 μm, can also be detectable and/or detected with the measured hazard value.

Particularly preferably, the hazard sensor unit can be portable or at least mobile. The hazard sensor unit can thus be transported to different locations and used at these locations. For example, the hazard sensor unit can be configured to be arranged on persons located at the construction site. The hazard sensor unit can also be configured to be arranged at one or more locations of the construction site. For example, the hazard sensor unit can be configured to be arranged on a wall, a ceiling, a floor, and/or another element of the construction site.

The manifestation of the hazard can be different in different areas. In particular, the manifestation of the hazard can depend on whether the hazard is detected in the vicinity of the person or remote from the person. The measured hazard value can thus depend on whether, for example in the event of monitoring dusts, the hazard sensor unit is arranged in the vicinity of the body, in particular of the head, of the person, or is located at a location remote from the person at the construction site.

Limit values for classifying the hazard can depend on the location, the manner and/or way of detecting the measured hazard value. For example, a limit value relating to radioactivity can depend on whether the radioactivity is measured directly on the body of a person or independently of a person, for example at a specific height above the floor of a room, and/or whether the radioactivity is measured in a building or in the open. The same can apply to a plurality of other types of hazards, for example dusts, vapors, generally concentrations of hazardous substances, for example gaseous hazardous substances, noise or the like.

Accordingly, it is particularly advantageous if the hazard sensor unit is configured to detect a type of use of the hazard sensor unit, in particular a space-related and/or person-based used of the hazard sensor unit. For this purpose, the hazard sensor unit can have a use type detector. The hazard sensor unit can thus automatically determine the type of use. An input by the person located at the construction site or generally by a user of the hazard management system, for example by means of an operating element such as a switch, is therefore not necessary. Incorrect operations of the hazard sensor unit can thus be avoided. In particular, it can also be detected whether the hazard sensor unit is in use by the person in a person-based manner—for example in which it is detected that the hazard sensor unit is carried—or that the hazard sensor unit is stored and in this respect a space-related measurement is carried out, for example by detecting that the hazard sensor unit is at rest.

The type of use may comprise different modes. For example, a use mode can correspond to a not-in-use mode of the hazard sensor unit, a use when arranged on the body of the person, or a use at a fixed location of the construction site remote from the person. The hazard sensor unit can thus be configured, for example, to distinguish “position” use modes such as, for example, “arranged on a person at a construction site”, “arranged in a stationary position in a construction site”, “in movement in a construction site not connected to a person”, and/or the like. Use modes can also relate to a distance, for example a height, for example a height above a floor, and/or a distance from a wall, a person and/or an object, in particular at the construction site.

The use type detector can be configured to detect accelerations of the hazard sensor unit. For this purpose, the hazard sensor unit can have an acceleration sensor.

Due to special damage potential, it is particularly advantageous if the hazard sensor unit is configured to detect a dust, in particular an dust capable of penetrating the alveoles, a silica-based and/or a wood-based dust as the hazard. For this purpose, the measured hazard value can relate to a dust, in particular a silica-based dust. Alternatively or additionally, the hazard sensor unit can also be configured to detect a damaging gas, for example carbon monoxide, as the hazard.

The measured hazard value can be determined by at least one particle concentration, a particle size, a particle distribution, and/or a chemical particle composition. Particle parameters of this kind can be determined particularly easily if the hazard sensor unit has an optical sensor unit for determining the measured hazard value. Alternatively or additionally, it is conceivable that the hazard sensor unit has a sensor unit which operates gravimetrically, acoustically, inductively and/or capacitively, for example, by resonance detuning of a resonant circuit, electrically, for example on the basis of a conductivity measurement, or mechanically, for example by evaluation of mechanical pulses. The sensor unit, in particular the optical sensor unit, can be placed in a housing of the hazard sensor unit. The signal-to-noise ratio of the measured hazard value can thereby be improved.

In a particularly preferred class of hazard sensor units, the hazard sensor unit has a position detector for detecting the position of the hazard sensor unit, in particular its sensor unit. The position detector can be based on a satellite-assisted position measuring system, for example GPS or Glonass or the like, and/or on a radio network-based position detection system, for example on the basis of WLAN or 5G, or the like.

It is also conceivable that the position detector has at least one time-of-flight sensor and/or an accelerometer, in particular a 3D accelerometer, and preferably with an integration unit.

A position can also be assigned to the measured hazard value by the position detector. This facilitates a later, spatially resolved evaluation of ascertained measured hazard values. The control unit can thus generate position-related and/or person-based warning signals. It can also control one or more pieces of construction equipment of the construction site in a position-related and/or person-based manner. For example, the control unit can be configured to deactivate, in a region of the construction site having a high manifestation of the hazard, a hazard-increasing, e.g. dust-producing, piece of construction equipment, and in regions with a low hazard exposure, to enable and/or activate such construction equipment for use.

The control unit can also be configured to locally displace one or more pieces of construction equipment as a function of obtained measured hazard values. For example, the control unit can be configured to cause a mobile air scrubber to move into a region with a high dust concentration and to clean the air there.

The hazard sensor unit can have a fastening device for releasable fastening, in particular to a person, to a piece of construction equipment, and/or to an element of the construction site, for example a wall and/or a ceiling. The hazard sensor unit can, for example, have a fastening device in the form of a retaining clip, so that it can easily be arranged on a piece of clothing of the person located at the construction site.

The fastening device can also be or at least comprise a belt, for example an armband, or the like, so that the hazard sensor unit can also be fastened to a body part of the person. For example, the hazard sensor unit can be arranged and/or is arranged in the region of the hip, for example on a hip belt, in the region of the breast, for example on a breast pocket, or in the head region, for example on a protective helmet, of the person.

It is also conceivable for the hazard sensor unit to be arranged on the construction equipment, for example the electric tool, a mobile and/or static deduster, a mobile and/or static air scrubber, a tripod and/or a dust helmet. The hazard sensor unit can then detect the presence of the hazard in the immediate surroundings. For example, the hazard sensor unit can detect, when mounted on the power tool, the dust production thereof.

The hazard sensor unit can have an output unit, in particular a mechanical, for example a vibration-generating, an acoustic and/or an optical output unit. If the hazard sensor unit is thus located in the vicinity of the person, and is accordingly carried by the person, for example, then the person can be informed and/or warned immediately before an excessive hazardous exposure, for example before too high a dust exposure.

In order to be able to remain ready for use even under adverse conditions, the hazard sensor unit can be designed to be at least protected from splashed water, and preferably be water-tight. The hazard sensor unit can correspond at least to a standard known as IP X4, for example IP 44 or IP 45. For this purpose, the hazard sensor unit can have a housing. The housing can be water-resistant to 50 m, preferably up to at least 100 m, water depth equivalent. The hazard sensor unit can furthermore, in particular with the exception of a sensor contact region which comes into contact with the hazard to be detected, for example dust, be designed to be dust-tight or at least substantially dust-tight.

The hazard sensor unit can have one or more operating elements. The hazard sensor unit can also have one or more display elements, for example an LED and/or a display unit.

In order to facilitate the person using the hazard sensor unit, it is particularly advantageous if the hazard sensor unit can be operated with a glove, in particular a construction glove. The construction glove can be, for example, a leather glove. In order for the hazard sensor unit to be operable in such a way, the size, position of at least one of the operating elements and/or at least one of the display elements of the hazard sensor unit can be adapted accordingly. In order to avoid faulty operation, the operating element(s) and/or the display element(s) can be arranged in one or more depressions and/or can be arranged such that they do not protrude, or at least substantially do not protrude from the parts of the hazard sensor unit surrounding them.

The hazard evaluation can also depend on an ambient temperature. It is therefore advantageous if the hazard sensor unit has a temperature sensor for detecting an ambient temperature.

In order to a comfortable wearing of the hazard sensor unit for the person, the hazard sensor unit should be as light as possible. A hazard sensor unit is therefore particularly preferred which weighs at most 100 g, particularly preferably at most 50 g.

The hazard sensor unit should have a sensitivity which allows a safe hazard evaluation, for example with regard to current standard specifications, of the measured hazard value. Preferably, the hazard sensor unit should measure at least one power of ten more precisely than a maximum permissible value corresponding to the default specification.

Furthermore, the scope of the invention includes a use of an inventive hazard management system on a construction site, in particular an elevated construction site and/or an underground construction site.

In particular, the use can take place in such a way that, in response to a detected hazard event at the construction site, at least one piece of construction equipment located at the construction site, in particular a suction device, a blower, a filter device, a mobile—preferably, portable and/or self-propelled—machine tool, is switched on, switched off, and/or regulated in its power. For this purpose, the hazard event can be a detection of a first limit value, for example a limit value of a maximum permissible dust concentration, in particular a maximum permissible silica concentration. The machine tool can be, for example, a rotary hammer machine, a chiseling machine, a grinding machine, a sawing machine, or the like.

Further features and advantages of the invention result from the following detailed description of exemplary embodiments of the invention, with reference to the figures of the drawing which shows details essential to the invention, and from the claims. The features shown there are not necessarily to be understood to scale and are shown in such a way that the special features according to the invention can be made clearly visible. The various features can each be implemented individually or in multiple combinations in variants of the invention.

Exemplary embodiments of the invention are shown in the schematic drawing and explained in more detail in the following description.

In the figures:

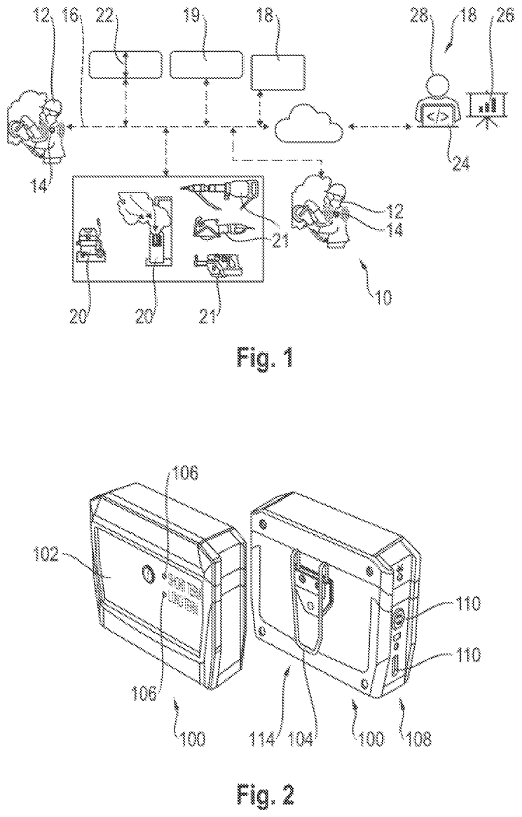

FIG. 1 shows a hazard management system in a schematic view;

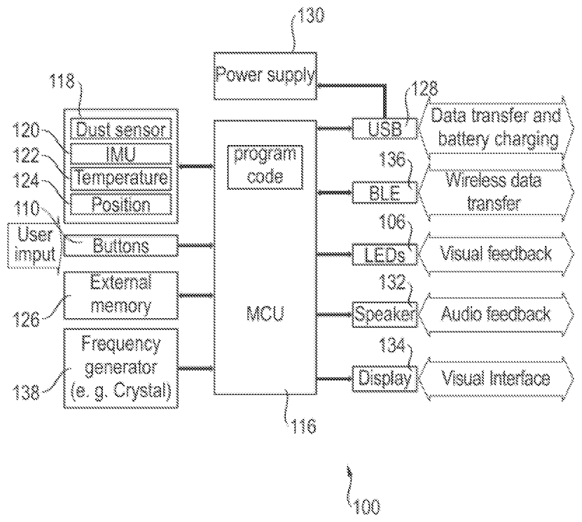

FIG. 2 shows perspective oblique views of a hazard sensor unit, and

FIG. 3 shows a block diagram of a hazard sensor unit.

In the following description of the figures, the same reference signs are used for the same or functionally corresponding elements to facilitate understanding of the invention.

FIG. 1 is a hazard management system 10 for monitoring hazards to which construction workers 12 are exposed. In particular, the hazard management system 10 is designed to monitor dust concentrations.

The construction workers 12 are carrying out on-site construction work, for example grinding work on walls and/or ceilings of the construction site. Due to the grinding work, the construction workers 12 are exposed to elevated dust concentrations.

Hazard sensor units 12 are approximately at the chest height of the construction workers 14.

As will be explained in more detail below, these hazard sensor units 14 are configured to detect dust concentrations present in the immediate surroundings of the respective construction workers 12.

Via a data network 16, the hazard sensor units 14 are integrated into the hazard management system 10.

In particular, data can be transmitted via the data network 16 to a control unit 18 of the hazard management system 10. In particular, measured hazard values determined by the hazard sensor units 14 can be transmitted to the control unit 18.

The measured hazard values can comprise, for example, a particle concentration, a particle type, a time and/or a duration of the detection of each of the measured hazard values. In particular, they describe the dusts detected by the hazard sensor units 14. They in particular allow detection of the concentration of silica particles and their average particle sizes.

Furthermore, position data relating to the positions of the hazard sensor units 14, and data about the respective types of use of the hazard sensor units 14, are transmitted to the control unit 18 via the data network 16.

The control unit 18 is configured to evaluate the obtained data and to analyze it with regard to existing hazard standards. The hazard standards to be taken into account are stored in the form of first and second limit values in a memory unit of the control unit 18.

Furthermore, construction equipment 20 and 21 are connected with the data network 16, and can be controlled by the control unit 18. The construction equipment 20 are configured to reduce the dust exposure during operation. They may be, for example, a construction vacuum cleaner, air scrubber or the like. In contrast, the construction equipment 21 can increase the dust exposure during operation. For example, it may be a hammer drill, a sawing machine or a chiseling machine. The construction equipment 20, 21 are also connected to the data network 16. For this purpose, they have corresponding data interfaces.

Furthermore, a portable output unit 19 in the form of a smartphone with an image display unit is connected to the data network 16. In addition, a gateway 22 which can establish a data connection between the data network 16 and further networks and/or devices (not shown in FIG. 1 in each case) is provided. The further networks can follow, for example, a different standard, in particular a different radio standard, than the data network 16.

The hazard sensor units 14, the gateway 22 and/or the control unit 18 can be configured to enrich the measured hazard values with further data. For example, they can be configured to add position data, temperature data, time stamp data, or the like to one or more measured hazard values.

A special feature of the hazard management system 10 shown here is that the control unit 18 is implemented in multiple components. In particular, a part of the control unit 18 is implemented as a cloud-based, remote computer unit 24. The computer unit 24 has a further output unit 26, which also has an image output unit. Via this remote computer unit 24 and the display unit 26, a user 28, for example, a user monitoring the hazard management system 10 and thus the construction site, can monitor hazards to which the construction workers 12 are exposed from a remote position.

It is conceivable that the remote computer unit 24 is connected to further hazard management systems, for example other construction sites (not shown in FIG. 1), in an analogous manner, for monitoring. The user 28 can thus obtain an overview of hazards prevailing on multiple construction sites. Protective measures can thus be defined and/or implemented in a comprehensive manner across construction sites.

For support, the control unit 18 is in particular configured to represent a heat map of the position-dependent determined measured hazard values on at least one of the output units 19, 26 and in particular on request by the user 28.

The control unit 18 is furthermore configured to output an acoustic warning signal, for example on a hazard sensor unit 14 corresponding to the given position, when a first limit value of a measured hazard value is exceeded, and thus to warn the construction worker 12. In addition, in this case, construction equipment 20 located in the vicinity of the given position is activated by the control unit 18, in particular automatically, in order to reduce the hazard—in this example excessive dust. If the activation of the construction equipment 20 does not lead to a sufficient reduction in the hazard within a predefined time, the control unit 18 is further configured to notify the construction workers 12 in question accordingly via the hazard sensor unit, and to deactivate construction equipment 21 located in the vicinity of the position or the construction worker 12, until the corresponding measured hazard value falls below a second limit value.

The hazard management system 10 thus makes it possible to detect the hazards existing on the monitored construction site or the monitored construction sites in real time, or at least substantially in real time.

Furthermore, the control unit 18 is configured to monitor the detected types of use of the relevant hazard sensor units 14. If, in a hazard sensor unit 14 which would be carried by one of the construction workers 12, a stationary position is detected, the control unit 18 in turn outputs a warning signal. A warning signal can also be output analogously if carrying is detected, although the hazard sensor unit 14 should measure in relation to space, and thus a call would be detected.

For documentation purposes, the control unit 18, in particular its cloud-based part, is configured to store time series of detected measured hazard values including the associated position data and the associated types of use of the corresponding hazard sensor units 14 in the database system of the computer unit 24. Corresponding hazard reports can be generated by the control unit 18 on request.

FIG. 2 shows a hazard sensor unit 100 in two perspective oblique views, in particular obliquely from the front (FIG. 2 at left) and obliquely from behind (FIG. 2 at right). Unless described otherwise, the above-described hazard sensor units 14 correspond, in particular functionally, to the hazard sensor unit 100.

On a rear side of its housing 102, a fastening device 104 in the form of a retaining clip is arranged. The fastening device 104 is used to fasten the hazard sensor unit 100 to an item of clothing of a construction worker 12 (see FIG. 1).

Two display elements 106, are located on a front side of the housing 102, each designed as an LED. The display elements 106 can indicate which type of measured hazard value is detected, in particular whether a long-term measurement value or a short-term measurement value is detected.

An operating element 110 is located in a recessed lateral region 108. This serves to manually switch on or off the hazard sensor unit 100 and for manual input of device settings. Furthermore, a USB connection 112 is formed in the rear side region 108. Due to the fact that the lateral region 108 is recessed relative to the surrounding housing 102, faulty operations, in particular of the operating element 110, are prevented. The dimensions of the operating element 110 and of the rear side region 108 are adapted for an operation by means of a commercially available construction glove.

The hazard sensor unit 100 is configured for dust detection and for measuring dust concentrations and for detecting particle types, in particular for detecting silica particle concentrations. For this purpose, air inlet openings 114 are formed on an underside of the housing 102, and through these, ambient air can move into the housing 102 up to a dust sensor unit located in the interior of the hazard sensor unit.

The hazard sensor unit 100 is designed as a portable device. It has a width of less than 20 cm, in particular approximately 10 cm, a height of less than 20 cm, in particular approximately 7 cm, and a thickness of less than 5 cm, in particular approximately 3 cm. Its weight is less than 500 g, in particular 50 g.

In one embodiment, the hazard sensor unit 100 additionally has an optical output unit in the form of a display unit (not shown in FIG. 2). This can be arranged, for example, on the front side of the housing 102.

FIG. 3 shows a block diagram of various functional components of the hazard sensor unit 100.

The hazard sensor unit 100 has a microcontroller unit 116 in which a program code for analysis of obtained measurement data is stored in an executable manner.

The above-mentioned dust sensor unit 118 is connected to the microcontroller unit 116. This is designed as an optical sensor for detecting dust concentrations, in particular for measuring silica-related dust concentrations. The dust sensor unit 118 is connected to the air inlet openings 114 designated in FIG. 2.

Furthermore, the hazard sensor unit 100 has an acceleration sensor 120. From acceleration measurement data obtained therefrom, in conjunction with its program code, the microcontroller unit 116 continuously determines the given type of use of the hazard sensor unit 100. In particular, a distinction is made, as the type of use, between a carrying of the hazard sensor unit 100 and a stationary position of the hazard sensor unit 100. The carrying is detected by the fact that characteristic patterns of acceleration data are detected by the acceleration sensor 120, whereas no, or at least substantially no, such patterns of acceleration data are detected during the stationary position. A space-related use can be associated with the stationary position. A machine learning algorithm is implemented in the program code for selecting and detecting the characteristic patterns.

Furthermore, the hazard sensor unit 100 has a temperature sensor 122. This is used to detect an ambient temperature which prevails in the immediate surroundings around the hazard sensor unit 100.

For detecting its position, the hazard sensor unit 100 furthermore has a position detector 124. Depending on the type and size of the construction sites in which the hazard sensor unit 100 is to be used, the position detector 124 can operate by satellite and/or on the basis of radio locating beacons. It is also conceivable for acceleration data from the acceleration sensor 120 to be used alternatively or additionally for position determination.

It is conceivable that the hazard sensor unit 100 also has further sensors in order to detect, for example, multiple types of hazards in parallel.

An external memory unit serves for a longer-term storage of the determined data 126.

The hazard sensor unit 100 furthermore has multiple data interfaces. In particular, it has a USB interface 128, via which, among other things, data transfer of obtained measured hazard values, determined types of use, position data, and/or analysis results as well as charging of a power supply 130 is possible.

Furthermore, the hazard sensor unit 100 has an acoustic output unit 132 in the form of a loudspeaker. This enables a direct output of warning signals or the like to a user of the hazard sensor unit 100. Instead of or in addition, an output unit comprising a vibration generator can also be provided.

In the above-mentioned alternative, the optical output unit 134 is further provided in the form of a display unit. With the output unit 134, information, for example measured hazard values, can be visually presented to the user of the hazard sensor unit 100. An optical warning signal, for example in the case of too high a dust exposure, can also be displayed on the optical output unit 122.

Furthermore, the hazard sensor unit 100 has a radio data interface 136 for communication with the data network 16 (FIG. 1). The radio data interface 136 preferably follows the same standard as the data network 16. Thus, via these data, the data also mentioned in relation to the USB interface 128 can be transmitted wirelessly to further elements or from further elements of the hazard management system 10 (FIG. 1).

Furthermore, FIG. 3 shows the operating element 110 and the display elements 106. Furthermore, the hazard sensor unit 100 has support components 138—a quartz oscillator, for example.

### LIST OF REFERENCE SIGNS

10 Hazard management system
12 Construction workers
14 Hazard sensor unit
16 Data network
18 Control unit
19 Output unit
20 Construction equipment
21 Construction equipment
22 Gateway
24 Computer unit
26 Output unit
28 User
100 Hazard sensor unit
102 Housing
104 Fastening device
106 Display element
108 Region
110 Operating element
112 Connection
114 Air inlet openings
116 Microcontroller unit
118 Sensor unit
120 Acceleration sensor
122 Temperature sensor
124 Position detector
126 Memory unit
128 Interface
130 Power supply
132 Output unit
134 Output unit
136 Radio data interface
138 Support component

1. A hazard sensor unit for a hazard management system for use on a construction site, wherein the hazard sensor unit is configured to determine at least one measured hazard value of the construction site for at least one hazard, and wherein the hazard sensor unit of is configured to detect a usage type of the hazard sensor unit.

2. The hazard sensor unit according to claim 1, wherein the hazard sensor unit is configured to detect a space-related and/or a person-related use of the hazard sensor unit as the usage type of the hazard sensor unit.

3. The hazard sensor unit according to claim 1, wherein the hazard sensor unit has an acceleration sensor, wherein the hazard sensor unit of is configured to determine the usage type with aid of the acceleration sensor.

4. The hazard sensor unit according to claim 1, wherein the hazard sensor unit is configured to record as the at least one hazard, a dust.

5. The hazard sensor unit according to claim 1, wherein the hazard sensor unit is configured to determine at least one of a particle concentration, a particle size, a particle distribution or a chemical particle composition as the at least one measured hazard value.

6. The hazard sensor unit according to claim 1, wherein the hazard sensor unit has an optical sensor unit for determining the at least one measured hazard value.

7. The hazard sensor unit according to claim 1, wherein the hazard sensor unit has a position detector for recording the position of the hazard sensor unit.

8. The hazard sensor unit according to claim 1, wherein the hazard sensor unit is configured to distinguish at least the usage modes of “arranged on a person at a construction site,” “deposited at a fixed location at a construction site” and/or “in motion at a construction site independently of a person” as the usage type.

9. The hazard sensor unit according to claim 1, wherein the hazard sensor unit can be operated with a glove.

10. A hazard management system for a construction site comprising
a hazard sensor unit according to claim 1,
wherein the hazard sensor unit is configured to determine at least one measured hazard value of the construction site for at least one hazard,
wherein the hazard sensor unit is configured to detect a usage type of the hazard sensor unit,
a control unit, and
a construction device,
wherein the control unit is configured to evaluate the at least one measured hazard value, and wherein the control unit is configured to control the construction device.

11. The hazard management system according to claim 1, wherein the control unit is configured to control the construction device when the at least one measured hazard value exceeds a first limit value.

12. The hazard management system according to claim 10, the construction device is or at least comprises a suction device, a blowing device and/or a filtering device.

13. The hazard management system according to claim 10, wherein the construction device is a construction robot or a hand-held machine tool or comprises the construction robot or the hand-held machine tool.

14. The hazard management system according to claim 10, wherein the at least one measured hazard value is a dust-related characteristic value.

15. The hazard management system according to claim 10, wherein the hazard management system is configured to determine a malfunction and/or an operating state of an element of the hazard management system as a function of the at least one measured hazard value.

16. The hazard management system according to claim 10, wherein the control unit comprises at least one cloud-based computer unit.

17. The hazard sensor unit according to claim 4, wherein the dust is an alveolar dust, a silica-based and/or a wood-based dust.

18. The hazard sensor unit according to claim 9, wherein the hazard sensor unit can be operated with a construction glove.

19. The hazard management system according to claim 10, wherein the hazard sensor unit is configured to detect a space-related and/or a person-related use of the hazard sensor unit.

20. The hazard management system according to claim 10, wherein the
wherein the control unit is configured to control the construction device to switch the construction device on, to switch it off and/or to set a working parameter, in particular its working power, and/or to give a user of the of the hazard management system a control signal for controlling the construction device.
